(19) United States
(12) Patent Application Publication
(10) Pub. No.: US 2023/0100785 A1
(43) Pub. Date: Mar. 30, 2023

(54) PRIORITY ENCODER-BASED TECHNIQUES FOR COMPUTING THE MINIMUM OR THE MAXIMUM OF MULTIPLE VALUES

(71) Applicant: NVIDIA CORPORATION, Santa Clara, CA (US)

(72) Inventors: Ilyas ELKIN, Sunnyvale, CA (US); Brent Ralph BOSWELL, Beaverton, OR (US); Stuart F. OBERMAN, Sunnyvale, CA (US); Ming Y. SIU, Santa Clara, CA (US)

(21) Appl. No.: 17/487,813

(22) Filed: Sep. 28, 2021

(51) Int. Cl. G06F 7/60; G06F 9/54

(52) U.S. Cl. CPC G06F 7/60; G06F 9/544

(57) ABSTRACT

In various embodiments, the maximum or minimum of multiple input values is determined. For each of a set of possible values, a corresponding detection result is set to indicate whether at least one of the input values matches the possible value. The detection results are used to ascertain the maximum or minimum of the multiple input values.

### BACKGROUND

### Field of the Various Embodiments

The various embodiments relate generally to computer processing systems and, more specifically, to priority encoder-based techniques for computing the minimum or the maximum of multiple values.

### DESCRIPTION OF THE RELATED ART

Floating point matrix multiplications are fundamental building blocks of many machine learning algorithms. A matrix multiplication between an m×n matrix A and an n×p matrix B produces an m×p matrix C, where element cᵢⱼ of C is the dot product of row i of A and column j of B and can therefore be expressed as cᵢⱼ=Σₖ₌₁ⁿ aᵢₖ bₖⱼ. To perform floating point matrix multiplications with a high throughput, some processors include collections of specialized hardware components referred to as “floating point matrix multiplication datapaths.”

In many floating point matrix multiplication datapaths, each floating point value is represented in the format mantissa×2^{exponent}. The mantissa is an integer represented via a sequence of bits and the exponent is an integer represented via a shorter sequence of bits. To efficiently align the decimal point across the mantissas when computing the sum of multiple floating point values (e.g., the n products aᵢₖ bₖⱼ), a datapath usually computes the maximum exponent of values and right shifts each value by the difference between the maximum exponent and the exponent of the value.

One approach to computing the maximum of n exponents involves implementing an n-input tree-based maximum circuit in the floating point matrix multiplication datapath. A tree-based maximum circuit is a binary tree of subcircuits, where each subcircuit includes, without limitation, a comparator that compares two inputs and a multiplexer that selects and outputs the maximum of the two inputs. The output of all but the last subcircuit is an input of a subcircuit in the next level. For example, a four-input tree-based maximum circuit includes, without limitation, two subcircuits in a top level and a single subcircuit in a bottom level. Each subcircuit in the top level computes a two-way maximum of a different pair of input values. The subcircuit in the last level computes and outputs the maximum of the two-way maximums.

One drawback of tree-based maximum circuits is that, as the depth of dot products have increased in accordance with advancements in semiconductor technology and architectures, tree-based maximum circuits have become performance bottlenecks for some floating point matrix multiplication datapaths. More specifically, the number of inputs to many tree-based maximum circuits have approximately doubled with each design generation (e.g., from four to eight to sixteen and even to thirty-two). Doubling the number of input values requires adding an additional level to the binary tree, and adding levels to the binary tree dramatically increases the delay of the tree-based maximum circuit, limiting achievable design clock frequency. As a result, the overall performance of the floating point matrix multiplication datapath is limited.

Another drawback of tree-based maximum circuits is that tree-based maximum circuits are not amenable to pipelining. As used herein “pipelining” refers to breaking logic into multiple stages via pipeline registers (e.g., flip-flops). The pipeline registers store signals between the stages to enable the stages to be executed on different data in parallel. In the context of a floating point matrix multiplication datapath, the exponents are typically stored in registers for subsequent shifting operations and therefore the number of additional registers required to pipeline a constituent maximum circuit corresponds to the internal structure of the maximum circuit. For a tree-based maximum circuit, the relatively large number of pipeline registers required to store the internal state of the binary tree can be an impediment to pipelining.

For explanatory purposes, scaling issues often associated with conventional maximum circuits implemented in floating point matrix multiplication datapaths are described above in the context of tree-based maximum circuits. Other types of conventional maximum circuits, however, also have undesirably high delays, have delays that increase excessively with the number of exponents, are difficult to pipeline, or any combination thereof.

As the foregoing illustrates, what is needed in the art are more effective techniques for computing maximum exponents in floating point dot product pipelines.

### SUMMARY

One embodiment of the present invention sets forth a circuit. The circuit includes a set of detection subcircuits, where each detection subcircuit included in the set of detection subcircuits computes a different detection result that is included in a set of detection results and indicates whether at least one input value included in a set of input values is equal to a different integer; and an encoder coupled to the set of detection subcircuits that determines an active bit from encoder input data, where each detection result included in the set of detection results is a different bit of the encoder input data, and encodes a bit position associated with the active bit to generate a maximum value.

At least one technical advantage of the disclosed techniques relative to the prior art is that, with the disclosed techniques, the delay incurred to double the number of exponents that are taken into account when computing maximum exponents is reduced. In that regard, with the disclosed techniques, because comparisons are performed between each exponent and possible values instead of between exponents, the increase in delay attributable to doubling the number of exponents is on the order of the delay of a two-input OR gate instead of the sum of the delays of a comparator and a multiplexer. Furthermore, because adding a pipeline stage to a tiered maximum circuit in a pipelined floating point matrix multiplication datapath involves storing only a portion of a single exponent, the tiered maximum circuit is well-suited for pipelining. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a maximum circuit, according to various embodiments;

FIG. 2 is a block diagram of the maximum circuit of FIG. 1 that operates on thirty-two four-bit input values, according to various embodiments;

FIG. 3 is a block diagram of a tiered maximum circuit, according to various embodiments;

FIG. 4 is a block diagram of the tiered maximum circuit of FIG. 3 that operates on thirty-two eight-bit input values, according to various embodiments;

FIG. 5 is a block diagram of a minimum/maximum circuit, according to various embodiments;

FIG. 6 is a flow diagram of method steps for computing the minimum or maximum of multiple values, according to various embodiments; and

FIG. 7 is a block diagram illustrating a system configured to implement one or more aspects of the various embodiments

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes only, multiple instances of like objects are denoted herein with reference numbers identifying the object and parenthetical alphanumeric character(s) identifying the instance where needed.

As described previously herein, many approaches to computing the sum of multiple floating point values involve computing the maximum exponent of the values. One approach to determining the maximum of n integer input values, such as exponents, involves implementing a tree-based maximum circuit. A tree-based maximum circuit is a binary tree of pairwise maximum subcircuits, where each pairwise maximum subcircuit computes the maximum of two inputs via a comparator and a multiplexer. One drawback of tree-based maximum circuits is that doubling the number of input values increases the delay by the sum of the delays of the comparator and the multiplexer. As a result, pairwise maximum trees have become performance bottlenecks for some floating point dot product computations. Another drawback of tree-based maximum circuits is that a substantial amount of area is needed to incrementally pipeline tree-based maximum circuits. When the area available for implementing the tree-based maximum circuit is limited, incrementally pipelining a tree-based maximum circuit can be unfeasible.

### Detecting the Maximum of Multiple Input Values

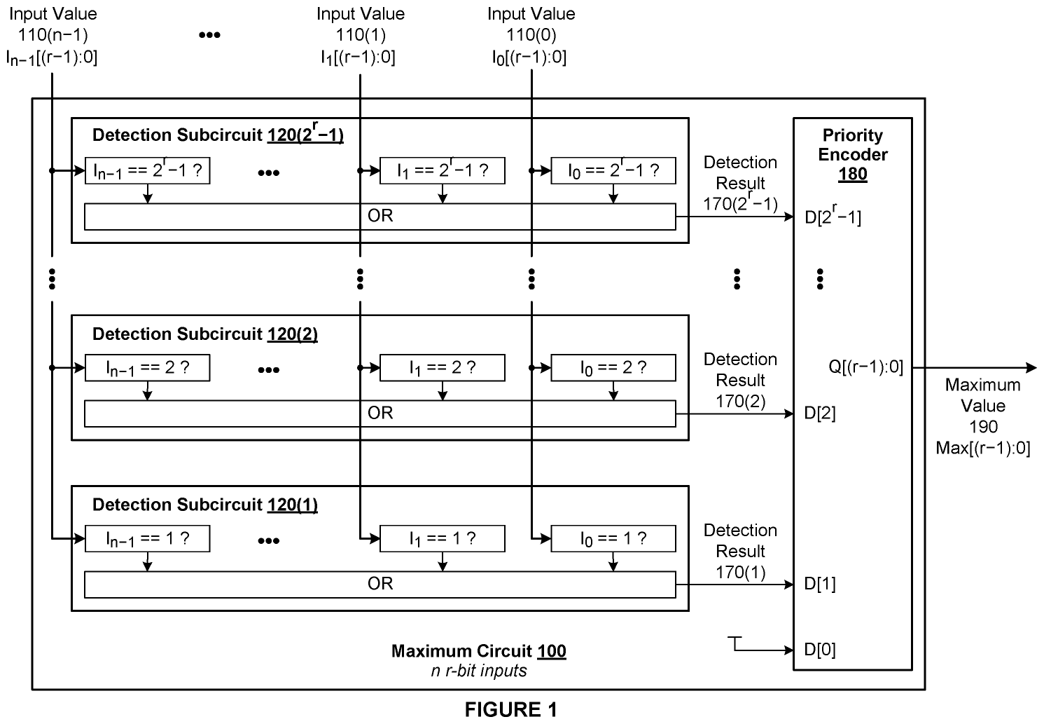

To address the above issues, in some embodiments, a maximum circuit does not directly compare input values to determine the maximum value. Instead, the maximum circuit detects the maximum possible value that is equal to or “matches” at least one of the input values. A parameterized version of a maximum circuit that is implemented in some embodiments is described in greater detail below in conjunction with FIG. 1.

FIG. 1 is a block diagram of a maximum circuit 100, according to various embodiments. As shown, the maximum circuit 100 computes a maximum value 190 based on input values 110(n−1)-110(0), where n can be any positive integer. The maximum value 190 is the maximum of the input values 110(n−1)-110(0). For explanatory purposes, the input values 110(n−1)-110(0) are also referred to herein individually as “the input value 110” and collectively as “the input values 110.” Each input value 110 is represented via r bits, where r can be any positive integer, and therefore the maximum value 190 is represented via r bits.

The input values 110(n−1)-110(0) are also denoted herein as respectively. The maximum value 190 is also denoted herein as “Max”. For explanatory purposes, FIGS. 1-7 use zero-based indexing and a bus notation format of “B[j:k]” to denote a portion of a multi-but value B corresponding to the bits of B at position j through position k. Accordingly, the input values 110(n−1)-110(0) and the maximum value 190 are also denoted herein as Iₙ₋₁[(r−1):0]-I₀[(r−1):0] and Max[(r−1):0], respectively. For explanatory purposes, in FIGS. 1-5, routing of multi-bit values is denoted via heavier lines than the routing of single-bit values.

In operation, the maximum circuit 100 sets the maximum value 190 equal to the maximum of the one or more values from possible values that match at least one of the input values 110. The possible values are the values that can be represented by r bits as per the integer representation associated with the input values 110. In some embodiments, including the embodiments depicted in FIGS. 1-7, the input values 110 and the maximum value 190 are unsigned integer values (e.g., exponents). In such embodiments, the r bits in each of the input values 110 can represent possible values from 0 through (2^{r}−1), inclusive. The maximum circuit 100 can determine the maximum of the one or more values from possible values that match at least one of the input values 110 in any technically feasible fashion. Determining the maximum of one or more values if also referred to herein as performing a “maximum computation.”

As shown, in some embodiments, the maximum circuit 100 includes, without limitation, detection subcircuits 120(2^{r}−1)-120(1) and a priority encoder 180. For explanatory purposes, the detection subcircuits 120(2^{r}−1)-120(1) are also referred to herein individually as “the detection subcircuit 120” and collectively as “the detection subcircuits 120.” The detection subcircuits 120(2^{r}−1)-120(1) generate detection results 170(2^{r}−1)-170(1), respectively, based on the input values 110(n−1)-110(0). For explanatory purposes, the detection results 170(2^{r}−1)-170(1) are also referred to herein individually as “the detection result 170” and collectively as “the detection results 170.”

More precisely, for an integer variable p from (2^{r}−1) through 1, the detection subcircuit 120(p) generates the detection result 170(p) that indicates whether at least one of the input values 110(n−1)-110(0) is equal to p. In some embodiments, if at least one of the input values 110(n−1)-110(0) is equal to p, then the detection subcircuit 120(p) generates the detection result 170(p) of ‘1.’ Otherwise, the detection subcircuit 120(p) generates the detection result 170(p) of ‘0.’ The detection subcircuits 120(2^{r}−1)-120(1) can perform any number and/or types of detection operations to generate the detection results 170(2^{r}−1)-170(1), respectively, in any technically feasible fashion.

In some embodiments, each detection subcircuit 120 includes, without limitation, a set of n match detectors and an n-wide OR component (e.g., an n-input OR gate, an OR tree, etc.). For an integer variable p from (2^{r}−1) through 1, each of the match detectors in the detection subcircuit 120(p) generates a different match value that indicates whether a different one of the input values 110 is equal to p. In some embodiments, if a match detector determines that the associated input value 110 matches the associated possible value p, then the match detector outputs a match value of ‘1’.

For explanatory purposes, the three match detectors that are included in the detection subcircuit 120(2^{r}−1) and correspond to the input values 110(n−1), 110(1), and 110(0) are denoted as boxes annotated with “Iₙ₋₁=2^{r}−1?,” “I₁=2^{r}−1?,” and “I₀=2^{r}−1?,” respectively to indicate the associated functionality. The three match detectors that are included in the detection subcircuit 120(2) and correspond to the input values 110(n−1), 110(1), and 110(0) are denoted as boxes annotated with “Iₙ₋₁=2?,” “I₁=2?,” and “I₀=2?,” respectively, to indicate the associated functionality. And the three match detectors that are included in the detection subcircuit 120(1) and correspond to the input values 110(n−1), 110(1), and 110(0) are denoted as boxes annotated with “Iₙ₋₁=1?,” “I₁=1?,” and “I₀=1?,” respectively, to indicate the associated functionality.

Each match detector can determine whether the associated input value 110 matches the associated possible value p in any technically feasible fashion. For instance, in some embodiments, each of the match detectors included in the detection subcircuit 120(2^{r}−1) is an r-wide AND component (not shown) that generates outputs a match value of ‘1’ if all of the bits of the corresponding input value 110 are equal to ‘1’ and a match value of ‘0’ otherwise. In the same or other embodiments, the n comparators in one or more of the detection subcircuits 120 are implemented via r exclusive NOR (“XNOR”) components and an r-wide AND component.

For an integer variable p from (2^{r}−1) through 1, within each detection subcircuit 120(p), the n match values associated with the possible value p are the inputs to the n-wide OR component (denoted as a wide box annotated with “OR”), and the output of the n-wide OR component is the detection result 170(p). Accordingly, if at least one of the input values 110(n−1)-110(0) is equal to p, then at least one of the match detectors in the detection subcircuit 120(p) generates a match value of ‘1’ and therefore the n-wide OR component in the detection subcircuit 120(p) generates the detection result 170(p) of ‘1’. Otherwise, each match detector in the detection subcircuit 120(p) generates a match value of ‘0’ and therefore the n-wide OR component in the detection subcircuit 120(p) generate the detection result 170(p) of ‘0’.

In some embodiments, the priority encoder 180 is a parallel priority encoder that receives 2^{r}-bit input data via a 2^{r}-bit input port denoted as D[(2^{r}−1):0], where the most significant bit (MSB) of the input data corresponds to D[2^{r}−1] and the least significant bit (LSB) of the input data corresponds to D[0]. The priority encoder 180 encodes the position of the most significant ‘1’ bit in the 2^{r}-bit input data to generate an r-bit binary value. The priority encoder 180 outputs the r-bit binary value via an r-bit output port that is denoted as Q[(r−1):0].

In some embodiments, the detection results 170(2^{r}−1)-170(1) are connected to D[(2^{r}−1):1], respectively, and therefore the bits at positions (2^{r}−1)−1 of the input data are equal to the detection results 170(2^{r}−1)-170(1), respectively. Although not shown, in some embodiments, a zeroth detection subcircuit generates a “zero detection result” that indicates whether at least one of the input values 110(n−1)-110(0) is equal to 0, the zero detection result is connected to D[0], and therefore the LSB of the input data is equal to the zero detection result.

Q[(r−1):0] is connected to Max[(r−1):0], and therefore the maximum value 190 is equal to the r-bit binary value that is generated by the priority encoder 180. In operation, because the position of the most significant ‘1’ bit of the input data is equal to the maximum of the one or more values from (2^{r}−1)−0 that match at least one of the input values 110, the priority encoder 180 sets the maximum value 190 equal to the maximum of the input values 110.

As shown, in some embodiments, to reduce the area of the maximum circuit 100, the maximum circuit 100 does not include a zeroth detection subcircuit and therefore does not generate a zero detection result. Instead, D[0] is tied high, and therefore the LSB of the input data is ‘1,’ enabling the priority encoder 180 to output an r-bit binary value of 0 via the output port Q[(r−1):0] if all of the input values 110(n−1)-110(0) are equal to 0. More specifically, if all of the input values 110(n−1)-110(0) are equal to 0, then the detection subcircuits 120(2^{r}−1)-120(1) output detection results 170(2^{r}−1)-170(1), respectively, that are all equal to zero, corresponding to 0 maximum value of all 0 input values.

Advantageously, because the maximum circuit 100 does not perform comparisons between the inputs values 110, negative impacts associated with increasing the number of input values 110 can be reduced. More specifically, in some embodiments, if the number of the input values 110 is doubled, then the n-wide OR gates included in the detection subcircuit 120(p) are the primary contributors to a resulting increase in delay of the maximum circuit 100. Because doubling the number of input values 110 requires adding a 2-input OR gate to each n-wide OR gate, the increase in delay of the maximum circuit 100 is on the order of the delay of the 2-input OR gate. By contrast, as described earlier herein, doubling the number of input values of a conventional tree-based maximum circuit can increase the delay of the conventional tree-based maximum circuit by at least the sum of the delays of a comparator and a multiplexer. As persons skilled in the art will recognize, the delay of a comparator alone is significantly greater than the delay of a 2-input OR gate.

Note that the techniques described herein are illustrative rather than restrictive and can be altered without departing from the broader spirit and scope of the invention. Many modifications and variations on the functionality described herein in the context of the maximum circuit 100, the detection subcircuits 120, the match detectors, the n-wide OR components, and the priority encoder 180 will be apparent to those of ordinary skill in the art without departing from the scope and spirit of the described embodiments.

In particular, in some embodiments, the functionality described herein is modified to implement a minimum circuit instead of or in addition to the maximum circuit 100. For instance, in some embodiments, a minimum circuit includes, without limitation, detection subcircuits 120(2^{r}−2)-120(1), a zeroth detection subcircuit, and a trailing one detector. Relative to the maximum circuit 100, the detection subcircuit 120(2^{r}−1) is replaced with the zeroth detection subcircuit and the priority encoder 180 is related with a trailing one detector. The zeroth detection subcircuit generates a “zero detection result” indicating whether at least one of the input values 110(n−1)-110(0) is equal to 0.

In some embodiments, the trailing one detector is an inverted version of the priority encoder 180 that encodes the position of the most significant ‘1’ bit in 2^{r}-bit “reverse input data” to generate an r-bit binary value, inverts the r-bit binary value, and outputs the r-bit binary value via an r-bit output port referred to herein as Qbar[(r−1):0]. In the same or other embodiments, the bit at position 0 of the input data and therefore position (2^{r}−1) of the reverse input data is driven by the zeroth detection result. The bits at positions 1−(2^{r}−2) of the input data and therefore positions (2^{r}−2)−1, respectively, of the reverse input data are driven by the detection results 170(1)-170(2^{r}−2), respectively. And the bit at position (2^{r}−1) of the input data and therefore position 0 of the reverse input data is tied high or driven by the detection result 170(2^{r}−1).

Any number of the techniques described herein can be implemented in any amount and/or types of software, hardware, or any combination thereof. In some embodiments, any number of maximum circuits can be implemented in any number and/or types of other circuits, datapaths, pipelines, functional units, execution units, or any other component of a processor in any technically feasible fashion. In some embodiments, each maximum circuit can be identical to zero or more other maximum circuits and can be different from zero or more maximum circuits. In the same or other embodiments, each parameter value associated with a maximum circuit (e.g., a value of n or r) can be identical to corresponding parameter values associated with zero or more other maximum circuits and can be different from corresponding parameter values associated with zero or more other maximum circuits.

In particular, the maximum circuit 100, the detection subcircuits 120(2^{r}−1)-120(1), the match detectors, the n-wide OR components, and the priority encoder 180 can be implemented in any technically feasible fashion. For instance, in some embodiments, the maximum circuit 100, the detection subcircuits 120(2^{r}−1)-120(1), the match detectors, the n-wide OR components, the priority encoder 180, the trailing one detector, or any combination thereof are synthesized based on a behavior description of the functionality described herein. For instance, in some embodiments, a truth table the directly encodes the leading one position or the trailing one position of input data is used to synthesize a priority encoder or a trailing one detector, respectively. In the same or other embodiments, the maximum circuit 100, the detection subcircuits 120(2^{r}−1)-120(1), the match detectors, the n-wide OR components, the priority encoder 180, or any combination thereof are implemented using one or more components from any number of standard cell libraries, any number of field-programmable gate array (FPGA) libraries, any number of other discrete components, any amount and/or type of custom logic and/or layout, or any combination thereof.

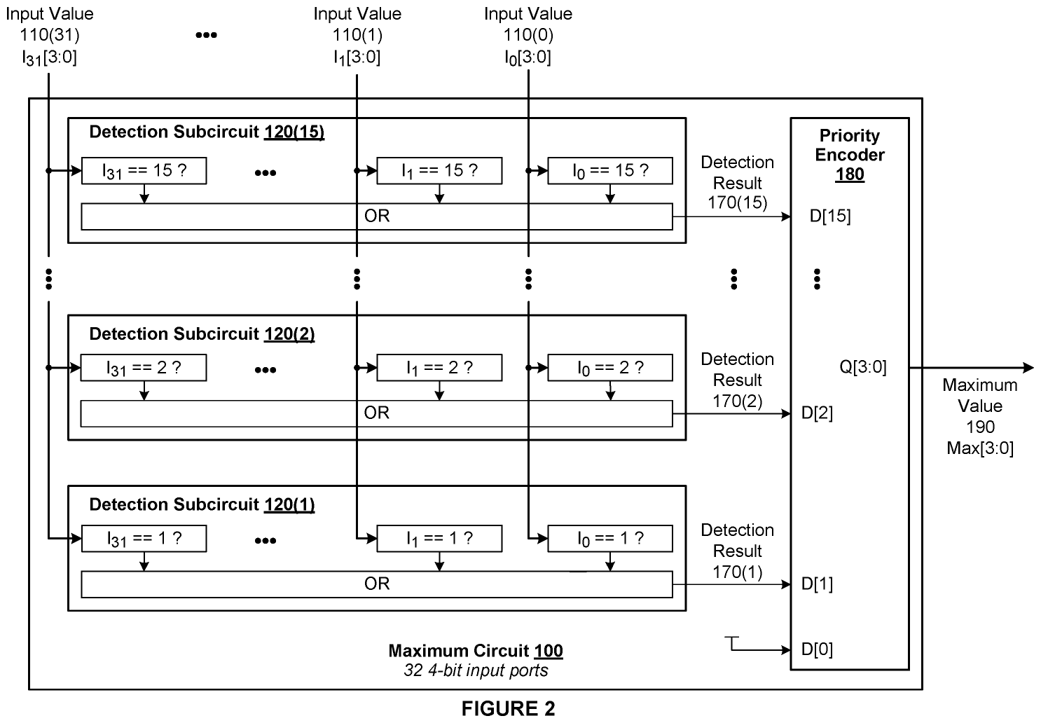

FIG. 2 is a block diagram of the maximum circuit 100 of FIG. 1 that operates on thirty-two four-bit input values, according to various embodiments. More precisely, in some embodiments, the maximum circuit 100 computes the maximum value 190 that is the maximum of the inputs values 110(31)-110(0). Each of the input values 110(31)-110(0) and the maximum value 190 are unsigned integer values that are each represented via four bits. With respect to FIG. 1, FIG. 2 depicts an embodiment in which n is 32, r is 4, and (2^{r}−1) is 15. Accordingly, the input values 110(31)-110(0) are also denoted as I₃₁[3:0]-I₀[3:0], respectively, and I₃₁-I₀, respectively. The maximum value 190 is also denoted as Max[3:0].

In operation, the maximum circuit 100 sets the maximum value 190 equal to the maximum of the one or more values from 15 through 0 that match at least one of the input values 110. As shown, in some embodiments, the maximum circuit 100 includes, without limitation, the detection subcircuits 120(3)-120(0) and the priority encoder 180. The detection subcircuits 120(3)-120(0) generate detection results 170(3)-170(0), respectively, based on the input values 110(31)-110(0).

For explanatory purposes, the detection subcircuits 120(15), 120(1), and 120(0) are explicitly depicted in FIG. 2. As shown, if any of the input values 110(31)-110(0) is equal to 15, then the detection subcircuit 120(15) sets the detection result 170(15) equal to ‘1.’ Otherwise, the detection subcircuit 120(15) sets the detection result 170(15) equal to ‘0.’ If any of the input values 110(31)-110(0) is equal to 2, then the detection subcircuit 120(2) sets the detection result 170(2) equal to ‘1.’ Otherwise, the detection subcircuit 120(2) sets the detection result 170(2) equal to ‘0.’ If any of the input values 110(31)-110(0) is equal to 1, then the detection subcircuit 120(1) sets the detection result 170(1) equal to ‘1.’ Otherwise, the detection subcircuit 120(1) sets the detection result 170(1) equal to ‘0.’

As shown, in some embodiments, the priority encoder 180 is a parallel priority encoder that receives 16-bit input data via the 16-bit input port denoted as D[15:0]. The priority encoder 180 encodes the position of the most significant ‘1’ bit in the 16-bit input data to generate a 4-bit binary value. The priority encoder 180 outputs the 4-bit binary value via the 4-bit output port that is denoted as Q[3:0].

In some embodiments, the detection results 170(15)-170(1) are connected to to D[15:1], respectively, and therefore the bits at positions 15-1 of the input data are equal to the detection results 170(15)-170(1), respectively. D[0] is tied high, and therefore the LSB of the input data Q[3:0] is connected to Max[3:0], and therefore the maximum value 190 is equal to the 4-bit binary value that is generated by the priority encoder 180. In operation, because the position of the most significant ‘1’ bit in the input data is equal to the maximum of the one or more values from 15-0 that match at least one of the input values 110, the priority encoder 180 sets the maximum value 190 equal to the maximum of the input values 110.

### Partitioning a Maximum Value Computation into Multiple Lower-Bit Maximum Value Computations

Oftentimes, different approaches to solving a problem (e.g., determining the maximum of multiple exponents) are associated with different trade-offs between any number and/or types of design characteristics. Some examples of design characteristics include, without limitation, latency, delay, throughput, power, and scalability. Referring back to FIG. 1, in some embodiments, the number of detection subcircuits 120 and therefore the area of the maximum circuit 100 increases exponentially with the number of bits in each input value 110. Accordingly, in some embodiments, if the number of bits on each input value 110 exceeds a bit threshold (e.g., 3 or 4), then meeting and/or optimizing any number and/or types of design criteria related to area can be difficult if not impossible.

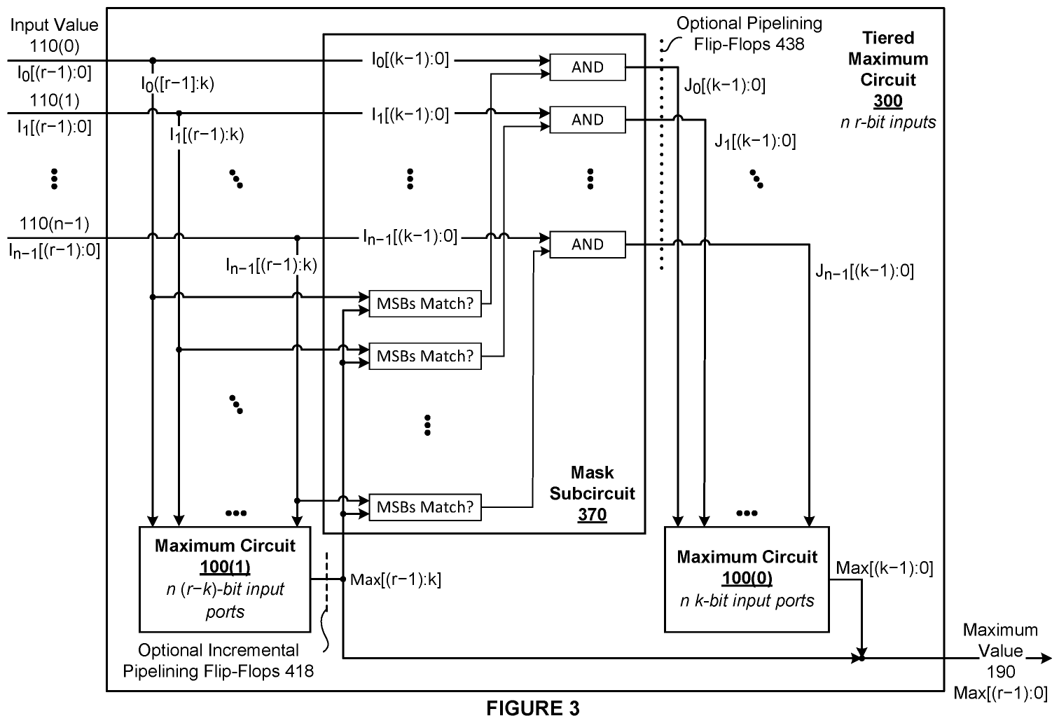

For this reason, in some embodiments, a tiered maximum circuit breaks a maximum value computation into inter-dependent sub-problems and sequentially solves the sub-problems via multiple maximum circuits. As described in greater detail below in conjunction with FIG. 3, in some embodiments, the tiered maximum circuit configures each maximum circuit to compute a different portion of the maximum value based on a subset of the corresponding portions of the input values. In some embodiments, because the number of bits in the individualized inputs of each constituent maximum circuit is reduced, the total area of the tiered maximum circuit is substantially reduced relative to a single maximum circuit that computes the entire maximum value. In the same or other embodiments, the delay of the tiered maximum circuit is greater than the sum of the delays of the constituent maximum circuits and is therefore greater than the delay of a comparable single maximum circuit.

In some embodiments, the different trade-offs inherent in the structure of maximum circuits and tiered maximum circuits provide opportunities to optimize maximum value computations based on any number and/or types of design requirements, design criteria, and the like, in any technically feasible fashion. For instance, in some embodiments, and as noted earlier, if the number of bits in each input of a maximum computation is greater than the bit threshold, then the maximum computation is implemented via a tiered maximum circuit. Otherwise, the maximum computation is implemented via a maximum circuit.

FIG. 3 is a block diagram of a tiered maximum circuit 300, according to various embodiments. As shown, the tiered maximum circuit 300 computes maximum value 190 based input values 110(n−1)-110(0), where n can be any positive integer. The maximum value 190 is the maximum of the input values 110(n−1)-110(0). Each input value 110 is represented via r bits, where r can be any positive integer, and therefore the maximum value 190 is represented via r bits.

As shown, in some embodiments, the tiered maximum circuit 300 includes, without limitation, a maximum circuit 100(1), a mask subcircuit 370, and a maximum circuit 100(0). In some embodiments, the maximum circuit 100(1) and the maximum circuit 100(0) are different instances of the maximum circuit 100 of FIG. 1. The maximum circuit 100(1) and the maximum circuit 100(0) can be identical or different.

In some embodiments, the maximum circuit 100(1) computes the (r−k)-bit maximum of n values received via n (r−k)-bit input ports, where where k is a positive integer that is less than r. In the same or other embodiments, the maximum circuit 100(0) computes the k-bit maximum of n values received via n k-bit input ports. In some embodiments, (r−k) can be equal to or different from k and therefore the maximum circuit 100(1) and the maximum circuit 100(0) can generate the same number or different numbers of bits of the maximum value 190.

In some embodiments, the tiered maximum circuit 300 routes the (r−k) MSBs of each of the input values 110(n−1)-110(0), denoted herein as Iₙ₋₁[(r−1):k]-I₀[(r−1):k], to then (r−k)-bit input ports of the maximum circuit 100(1). In response, the maximum circuit 100(1) generates the (r−k) MSBs of the maximum value 190, denoted herein as Max[(r−1):k].

As shown, in the same or other embodiments, the mask subcircuit 370 drives the n (r−k)-bit input ports of the maximum circuit 100(0) based on the (r−k) MSBs of the maximum value 190 and the input values 110(n−1)-110(0). For an integer variable i from (n−1) to 0, if the (r−k) MSBs of the input value 110(i), denoted herein as Iᵢ[(r−1):k], is equal to the (r−k) MSBs of the maximum value 190 denoted Max[(r−1):k], then the mask subcircuit 370 routes Iᵢ[(k−1):0] to the i^{th} input port of the maximum circuit 100(0). Otherwise, the mask subcircuit 370 routes a k-bit 0 value to the i^{th} input port of the maximum circuit 100(0). In this fashion, the mask subcircuit 370 removes or “masks” the zero or more input values 110 having MSBs that do not match the MSBs of the maximum value 190 previously computed by the maximum circuit 100(1). The mask subcircuit 370 can generate values that drive the input ports of the maximum circuit 100(0) in any technically feasible fashion.

In some embodiments, the mask subcircuit 370 includes, without limitation, n comparator/AND pairs. For an integer variable i from (n−1) to 0, the i^{th} comparator/AND pair routes Iᵢ[(k−1):0] or a k-bit 0 to the i^{th} input port of the maximum circuit 100(0). More precisely, a comparator in the i^{th} comparator/AND pair compares Iᵢ[(r−1):k] and Max[(r−1):k] to generate an i^{th} match value that is ‘1’ if Iᵢ[(r−1):k] is equal to Max[(r−1):k] and ‘0’ otherwise. For each of the k bits in Iᵢ[(k−1):0], an AND component in the i^{th} comparator/AND pair performs a logical AND between the i^{th} match value and each of the k bits in I_{index}[(k−1):0] to generate a k-bit output value that is denoted as Jᵢ[(k−1):0]. As shown, the k-bit output value denoted as Jᵢ[(k−1):0] is routed to the i^{th} input port of the maximum circuit 100(0).

For explanatory purposes, the comparators corresponding to the input values 110(0), 110(1), and 110(N−1) are explicitly depicted in FIG. 3 as boxes annotated with “MSBs Match?.” The AND components corresponding to the input values 110(0), 110(1), and 110(N−1) are explicitly depicted in FIG. 3 as boxes annotated with “AND.”

As shown, in response to the n k-bit values received via the inputs ports of the maximum circuit 100(0), the maximum circuit 100(0) generates the k LSBs of the maximum value 190, denoted herein as Max[(k−1):0]. Accordingly, Max[(k−1):0] is equal to the maximum of the subset of input values 110 that have (r−k) MSBs that are equal to the (r−k) MSBs of the maximum value 190. The tiered maximum circuit 300 then outputs the maximum value 190.

In some other embodiments, instead of sequentially solving two sub-problems via two maximum circuits to generate the maximum value 190, the tiered maximum circuit 300 sequentially solves m sub-problems, where m is greater than two, via m maximum circuits to generate the maximum value 190. In the same or other embodiments, the tiered maximum circuit 300 includes, without limitation, m maximum circuits and (m−1) mask subcircuits.

Each of the m maximum circuits generates a different portion of the maximum value 190, where each portion of the maximum value corresponds to a different a different, non-overlapping, bit position sequence. Together, the bit position sequences span from the MSB to the LSB of the maximum value 190. Each bit position sequence can have the same number of bits as zero or more other bit position sequences and can have a different number of bits from zero for more other bit position sequences. For explanatory purposes, an (m−1)th maximum circuit is associated with a (m−1)th bit position sequence that includes the bit position of the MSB of the maximum value 190, an (m−2)th maximum circuit is associated with the next highest bit position sequence, and so forth. A 0^{th} maximum circuit is associated with a 0^{th} bit position sequence that includes the bit position of the LSB of the maximum value 190.

In some embodiments, the (m−1)th maximum circuit computes the (m−1)th portion of the maximum value 190 that includes the MSB based on the corresponding portions of the input values 110(n−1) to 110(0). For an integer j from (m−2) through 0, a j^{th} mask subcircuit routes the j^{th} portion of each input value 110 in a j^{th} matching subset of the input values 110 to a corresponding input of the j^{th} maximum circuit and a value of zero to each of the other inputs ports of the j^{th} maximum circuit. The j^{th} matching subset of the input values 110 includes the one or more input values 110 having MSBs that match the MSBs of the maximum value 190 already computed by the one or more preceding maximum circuits. The j^{th} maximum circuit computes the j^{th} portion of the maximum value 190 based on j^{th} portions of the one or more input values 110 in the j^{th} matching subset of the input values 110. After the 0^{th} maximum circuit computes the LSB of the maximum value 190, the tiered maximum circuit 300 outputs the maximum value 190.

In some embodiments, each of any number of tiered maximum circuits can partition the corresponding bit positions of a maximum value into multiple bit position sequences in any technically feasible fashion and based on any number and/or types of criteria. In some embodiments, to optimize a trade-off between delay and area, each tiered maximum circuit partitions the corresponding bit positions into the smallest number of bit position sequences that each have four bits or less. In the same or other embodiments, a tiered maximum circuit computes a nine-bit maximum value denoted herein as Max[8:0] via three maximum circuits that compute Max[8:6], Max[5, 3], and Max[2:0], respectively.

Advantageously, because the input values of each maximum circuit in a tiered maximum circuit are determined by the input values of the tiered maximum circuit and any previously computed MSBs of the maximum value, tiered maximum circuits are particularly well-suited to pipelining when the input values of the tiered maximum circuit are already stored. For instance, in some embodiments, to add a pipeline stage to the tiered maximum circuit after a maximum circuit, registers are used to store the output of maximum circuit. Accordingly, adding a pipeline stage involves storing only a portion of the maximum value. For instance, and as depicted via a dashed line, in some embodiments, the input values 110(1)-110(n) are already stored for use in a floating-point sum, and the tiered maximum circuit 300 is pipelined via optional incremental pipelining flip-flops 418 that store Max[(r−1):k].

In some other embodiments, although the input values of each maximum circuit in a tiered maximum circuit are not already stored, the regular structure of the tiered maximum circuit facilitate efficient pipelining at any number of locations. For instance, and as depicted via a dotted line, in some embodiments, the tiered maximum circuit 300 is pipelined via optional pipelining flip-flops 438 that store Jₙ₋₁[k:0]-J₀[k:0].

The tiered maximum circuit 300, zero or more other tiered maximum circuits, the maximum circuits 110(1) and 110(0), zero or more other maximum circuits, the comparator/AND pairs, the comparators, and the AND components can be implemented in any technically feasible fashion. For instance, in some embodiments, the tiered maximum circuit 300, zero or more other tiered maximum circuits, the maximum circuits 110(1) and 110(0), zero or more other maximum circuits, the comparator/AND pairs, the comparators, the AND components, or any combination thereof are synthesized based on a behavior description of the functionality described herein. In the same or other embodiments, the tiered maximum circuit 300, zero or more other tiered maximum circuits, the maximum circuits 110(1) and 110(0), zero or more other maximum circuits, the comparator/AND pairs, the comparators, the AND components, or any combination thereof are implemented using one or more components from any number of standard cell libraries, any number of FPGA libraries, any number of other discrete components, any amount and/or type of custom logic and/or layout, or any combination thereof.

Note that the techniques described herein are illustrative rather than restrictive and can be altered without departing from the broader spirit and scope of the invention. Many modifications and variations on the functionality described herein in the context of the tiered maximum circuit 300, the maximum circuits 110(1) and 110(0), the comparator/AND pairs, the comparators, and the AND components will be apparent to those of ordinary skill in the art without departing from the scope and spirit of the described embodiments.

In particular, the functionality described herein can be modified to implement a tiered minimum circuit (not shown) instead of or in addition to the tiered maximum circuit 300. For instance, in some embodiments, a tiered minimum circuit is a modified version of the tiered maximum circuit 300 in which the maximum circuit 100(1) and the maximum circuit 100(0) are replaced with a first minimum circuit and a zeroth minimum circuit, respectively, but the mask subcircuit 370 and the routing are unchanged. In operation, the first minimum circuit and the zeroth minimum circuit generate the (r−k) MSBs and the k LSBs, respectively, of the minimum value of the input values 110(n−1)-110(0).

Any number of the techniques described herein can be implemented in any amount and/or types of software, hardware, or any combination thereof. In some embodiments, any number of tiered maximum circuits that include any number of maximum circuits and zero or more other maximum circuits can be implemented in any number and/or types of other circuits, datapaths, pipelines, functional units, execution units, or any other component of a processor in any technically feasible fashion. In some embodiments, each tiered maximum circuit can be identical to zero or more other tiered maximum circuits and can be different from zero or more tiered maximum circuits. In the same or other embodiments, each maximum circuit can be identical to zero or more other maximum circuits and can be different from zero or more maximum circuits.

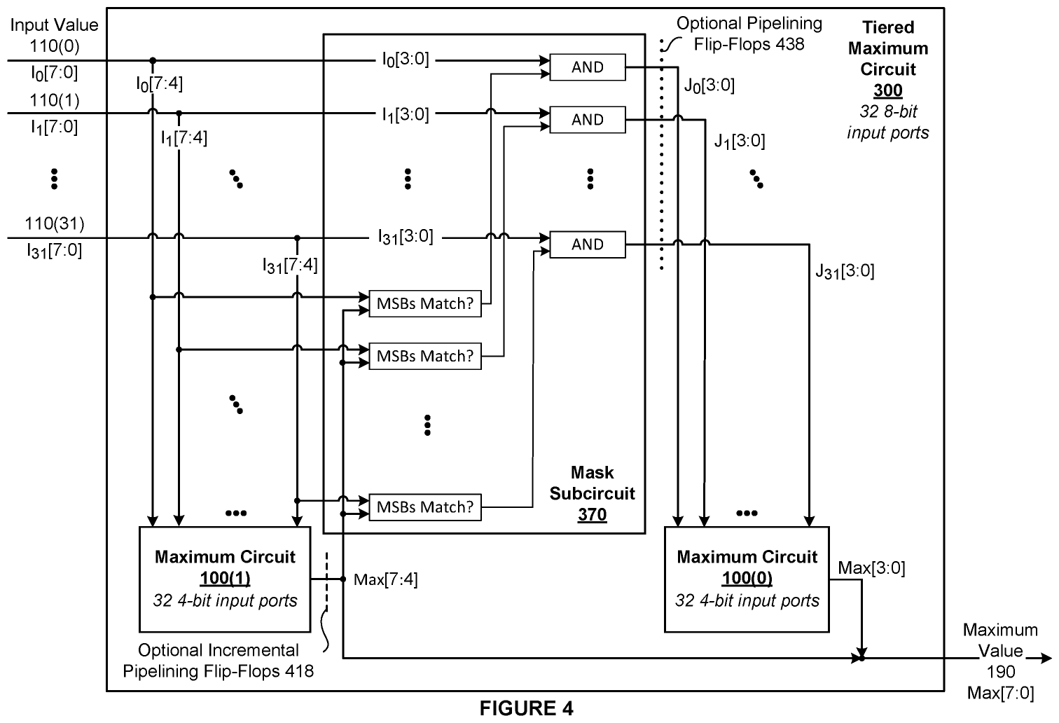

FIG. 4 is a block diagram of the tiered maximum circuit 300 of FIG. 3 that operates on thirty-two eight-bit input values, according to various embodiments. More precisely, in some embodiments, the tiered maximum circuit 300 computes the maximum value 190 that is the maximum of the inputs values 110(31)-110(0). Each of the input values 110(31)-110(0) and the maximum value 190 are unsigned integer values that are each represented via eight bits. With respect to FIG. 3, FIG. 4 depicts an embodiment in which n is 32 and r is 8. Accordingly, the input values 110(31)-110(0) are also denoted as I₃₁[7:0]-I₀[7:0], respectively, and I₃₁-I₀, respectively. The maximum value 190 is also denoted as Max[7:0].

As shown, in some embodiments, the tiered maximum circuit 300 includes, without limitation, maximum circuit 100(1), mask subcircuit 370, and maximum circuit 100(0). Each of the maximum circuits 110(1) and 110(0) computes the four-bit maximum of thirty-two values received via thirty-two four-bit input ports.

In some embodiments, the tiered maximum circuit 300 routes the four MSBs of each of the input values 110(31)-110(0), denoted herein as I₃₁[7:4]-I₀[7:4], to the input ports of the maximum circuit 100(1). In response, the maximum circuit 100(1) generates the four MSBs of the maximum value 190, denoted herein as Max[7:4]. As shown, the mask subcircuit 370 drives the thirty-two four-bit input ports of the maximum circuit 100(0) based on Max[7:4] and the input values 110(n−1)-110(0). For an integer variable i from (n−1) to 0, the mask subcircuit 370 generates an output value denoted as Jᵢ[3:0] that is routed to the i^{th} input port of the maximum circuit 100(0). If Iᵢ[7:4] is equal to Max[7:4], then Jᵢ[3:0] is equal to Jᵢ[3:0]. Otherwise, Jᵢ[3:0] is equal to ‘0000’. In response, the maximum circuit 100(0) generates Max[3:0]. The tiered maximum circuit 300 then outputs the maximum value 190.

In some embodiments, and as depicted via a dashed line, the input values 110(1)-110(31) are already stored for use in a floating-point sum, and the tiered maximum circuit 300 is pipelined via optional incremental pipelining flip-flops 418 that store Max[7:4]. In some other embodiments, the tiered maximum circuit 300 is pipelined via optional pipelining flip-flops 438 that store J₃₁[3:0]-J₀[3:0].

### Executing a Minimum/Maximum Instruction

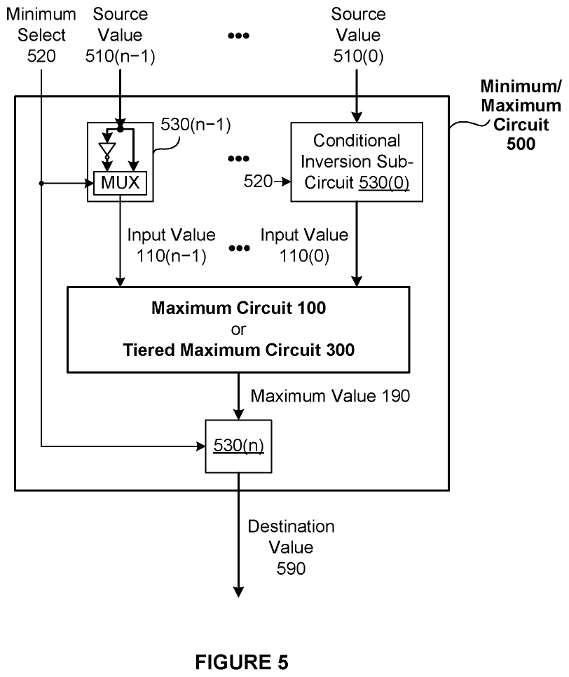

FIG. 5 is a block diagram of a minimum/maximum circuit 500, according to various embodiments. As, in some embodiments, the minimum/maximum circuit 500 computes an output value 590 based on a minimum select 520 and source values 510(n−1)-510(0), where n can be any positive integer. In the same or other embodiments, the minimum/maximum circuit 500 computes the output value 590 in response to a minimum/maximum instruction that specifies, without limitation, the minimum select 520 and the source values 510.

Although not shown in FIG. 5, each of source values 510(n−1)-510(0) and the output value 590 is represented via r bits, where r can be any positive integer. In the same or other embodiments, the r bits of each of the source values 510(n−1)-510(0) and the output value 590 represent an unsigned integer value (e.g., an exponent). If the minimum select 520 is enabled (e.g., equal to ‘1’), then the minimum/maximum circuit 500 sets the output value 590 equal to the minimum of the source values 510(n−1)-510(0). Otherwise, the minimum/maximum circuit 500 sets the output value 590 equal to the maximum of the source values 510(n−1)-510(0). The maximum and the minimum of the source values 510(n−1)-510(0) are also referred to herein as a “maximum value,” and a “minimum value,” respectively, of the source values 510(n−1)-510(0).

As shown, in some embodiments, the minimum/maximum circuit 500 includes, without limitation, conditional inversion subcircuits 530(n)-530(0) and the maximum circuit 100 of FIG. 1 or the tiered maximum circuit 300 of FIG. 3. Each of the conditional inversion subcircuits 530(n)-530(0) includes, without limitation, one or more inverters and one or more multiplexers, where each multiplexer is denoted as “MUX.”

In some embodiments, if the minimum select 520 is enabled, then the conditional inversion subcircuits 530(n−1)-530(0) invert the source values 510(n−1)-510(0) to generate the input values 110(n−1)-110(0) described previously herein in conjunction with FIGS. 1 and 3. Otherwise, the conditional inversion subcircuits 530(n−1)-530(0) set the input values 110(n−1)-110(0) equal to the source values 510(n−1)-510(0), respectively.

As shown, the maximum circuit 100 or the tiered maximum circuit 300 computes the maximum value 190 that is equal to the maximum of the input values 110(n−1)-110(0). If the minimum select 520 is enabled, then the conditional inversion subcircuit 530(n) inverts the maximum value 190 to generate the output value 590 that is equal to the minimum of the source values 510(n−1)-510(0). Otherwise, the conditional inversion subcircuit 530(n) sets the output value 590 equal to the maximum value 190 that is equal to the maximum of the source values 510(n−1)-510(0).

Note that the techniques described herein are illustrative rather than restrictive and can be altered without departing from the broader spirit and scope of the invention. In some other embodiments, any number and/or types of circuits can use any number of maximum circuits, any number of tiered maximum circuits, or any combination thereof to generate the minimum or the maximum of any number of source values in any technically feasible fashion.

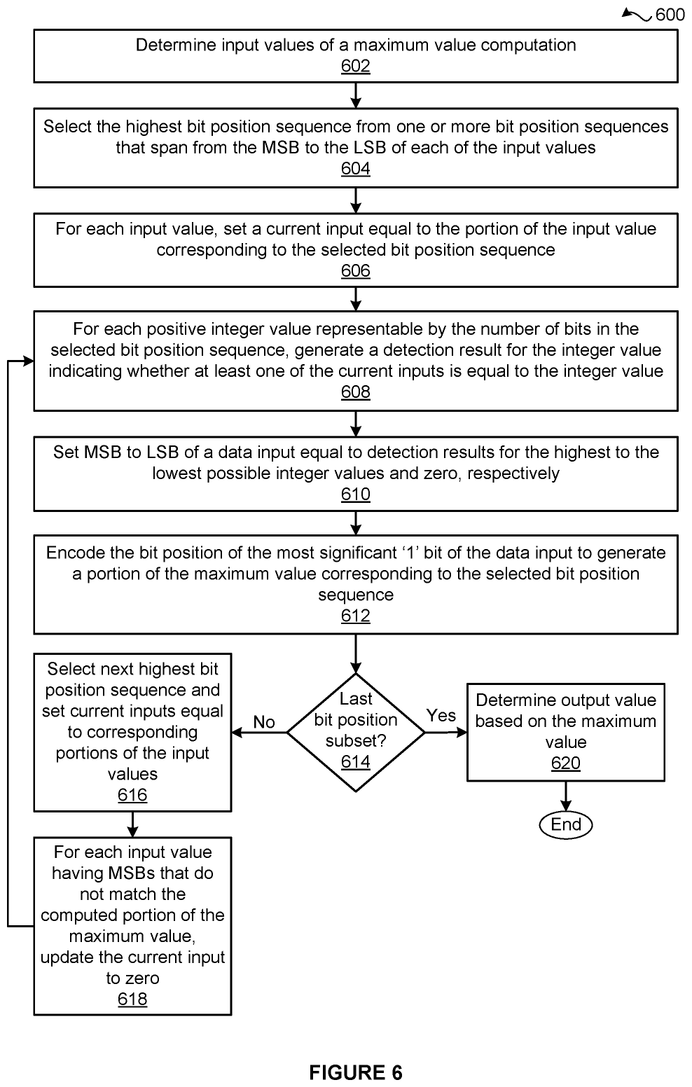

FIG. 6 is a flow diagram of method steps for computing the minimum or maximum of multiple values, according to various embodiments, Although the method steps are described with reference to the systems of FIGS. 1-5, persons skilled in the art will understand that any system configured to implement the method steps, in any order, falls within the scope of the present invention.

As shown, a method 600 begins at step 602, where a component that is implemented in software, hardware, or any combination thereof determines input values 110 of a maximum value computation. In some embodiments, the component can be the maximum circuit 100, the tiered maximum circuit 300, the minimum/maximum circuit 500, etc., and the component can determine the input values in any technically feasible fashion. At step 604, the component selects the highest bit position sequence from one or more bit position sequences that span from the MSB to the LSB of each of the input values 110. At step 606, for each of the input values 110, the component sets a current input equal to the portion of the input value 110 corresponding to the selected bit position sequence.

At step 608, for each positive integer value representable by the number of bits in the selected bit position sequence, the component generates a detection result for the integer value indicating whether at least one of current inputs is equal to the integer value. At step 610, the component sets the MSB to the LSB of a data input equal to the detection results for the highest to the lowest possible integer values and zero, respectively. At step 612, the component encodes the bit position of the most significant ‘1’ bit of the data input to generate a portion of the maximum value corresponding to the selected bit position sequence

At step 614, the component determines whether the selected bit position sequence is the last bit position sequence. If, at step 614, the component determines that the selected bit position sequence is not the last bit position sequence, then the method 600 proceeds to step 616. At step 616, the component selects the next highest bit position sequence and sets the current inputs equal to corresponding portions of the input values. At step 618, for each input value having MSBs that do not match the computed portion of the maximum value, the component updates the current input to zero. The method 600 then returns to step 608, where the component generates a new detection result for each integer value based on the current inputs.

If, however, at step 614, the component determines that the selected bit position sequence is the last bit position sequence, then the method 600 proceeds directly to step 620. At step 620, the component determines the output value based on the maximum value. The method 600 then terminates.

### Exemplary System Overview

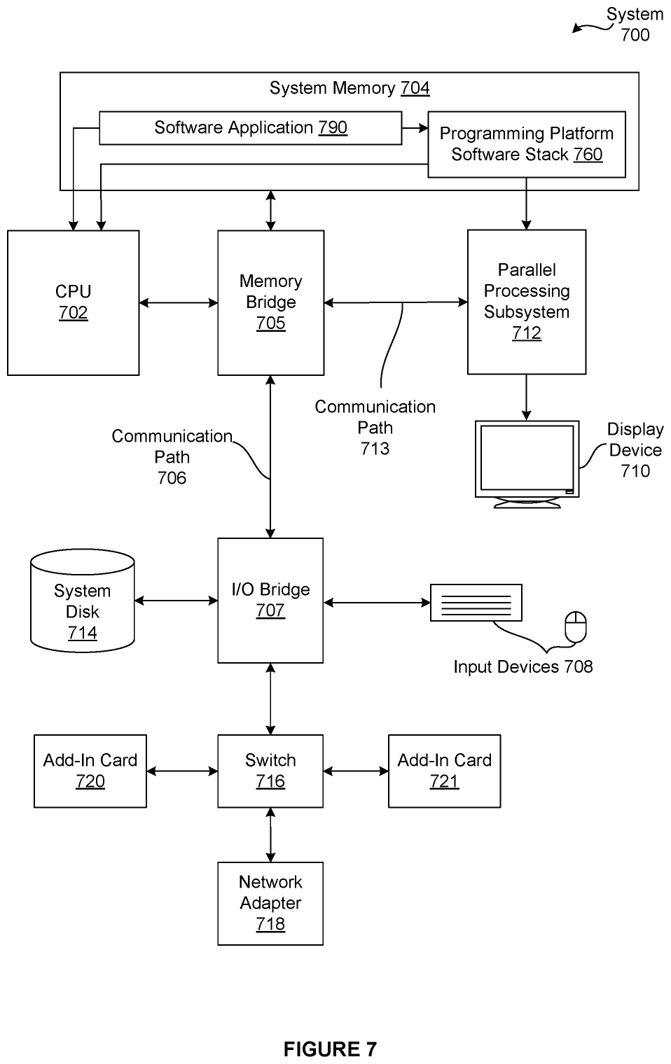

FIG. 7 is a block diagram illustrating a system 700 configured to implement one or more aspects of the various embodiments. As shown, the system 700 includes, without limitation, a central programming unit (CPU) 702 and a system memory 704 coupled to a parallel processing subsystem 712 via a memory bridge 705 and a communication path 713. In some embodiments, at least a portion of the system memory 704 is host memory associated with the CPU 702. The memory bridge 705 is further coupled to an input/output (I/O) bridge 707 via a communication path 706, and the I/O bridge 707 is, in turn, coupled to a switch 716.

In operation, the I/O bridge 707 is configured to receive user input information from input devices 708, such as a keyboard or a mouse, and forward the input information to the CPU 702 for processing via the communication path 706 and the memory bridge 705. The switch 716 is configured to provide connections between the I/O bridge 707 and other components of the system 700, such as a network adapter 718 and add-in cards 720 and 721.

As also shown, the I/O bridge 707 is coupled to a system disk 714 that can be configured to store content, applications, and data for use by the CPU 702 and the parallel processing subsystem 712. As a general matter, the system disk 714 provides non-volatile storage for applications and data and can include fixed or removable hard disk drives, flash memory devices, compact disc read-only memory, digital versatile disc read-only memory, Blu-ray, high definition digital versatile disc, or other magnetic, optical, or solid-state storage devices. Although not explicitly shown, other components, such as a universal serial bus or other port connections, compact disc drives, digital versatile disc drives, film recording devices, and the like, can be connected to the I/O bridge 707 as well.

In various embodiments, the memory bridge 705 can be a Northbridge chip, and the I/O bridge 707 can be a Southbridge chip. In addition, the communication paths 706 and 713, as well as other communication paths within the system 700, can be implemented using any technically suitable protocols, including, without limitation, Peripheral Component Interconnect Express, Accelerated Graphics Port, HyperTransport, or any other bus or point-to-point communication protocol known in the art.

In some embodiments, the CPU 702 is the master processor of the system 700, controlling and coordinating operations of other system components. In the same or other embodiments, the CPU 702 issues commands that control the operation of the one or more parallel processors (not shown) included in the parallel processing subsystem 712. As referred to herein, a “parallel processor” can be any computing system that includes, without limitation, multiple physical units of simultaneous execution (e.g., processor cores, streaming multiprocessors, etc.) that can be configured to perform any number and/or types of computations.

In some embodiments, each parallel processor can be a parallel processing unit (PPU), a graphics processing unit (GPU), a tensor processing unit, a multi-core central processing unit (CPU), an intelligence processing unit, a neural processing unit, a neural network processor, a data processing unit, a vision processing unit, or any other type of processor or accelerator that can presently or in the future support parallel execution of multiple threads.

In some embodiments, the parallel processors can be identical or different, and each parallel processor can be associated with dedicated parallel processing memory or no dedicated memory. In some embodiments, the parallel processing memory associated with a given parallel processor includes, without limitation, one or more types of dynamic random access memory (DRAM). In the same or other embodiments, each set of instructions (e.g., a program, a function, etc.) or “kernel” that executes on a given parallel processor resides in the parallel processing memory of the parallel processor.

In some embodiments, the parallel processing subsystem 712 incorporates circuitry optimized for general-purpose processing. Such circuitry can be incorporated across one or more parallel processors that can be configured to perform general-purpose processing operations. In the same or other embodiments, the parallel processing subsystem 712 further incorporates circuitry optimized for graphics processing. Such circuitry can be incorporated across one or more parallel processors that can be configured to perform graphics processing operations. In the same or other embodiments, any number of parallel processors can output data to any number of display devices 710. In some embodiments, zero or more of the parallel processors can be configured to perform general-purpose processing operations but not graphics processing operations, zero or more of the parallel processors can be configured to perform graphics processing operations but not general-purpose processing operations, and zero or more of the parallel processors can be configured to perform general-purpose processing operations and/or graphics processing operations.

In some embodiments, the parallel processing subsystem 712 can be integrated with one or more other elements of FIG. 7 to form a single system. For example, the parallel processing subsystem 712 can be integrated with the CPU 702 and other connection circuitry on a single chip to form a system on a chip. In the same or other embodiments, any number of CPUs 702 and any number of parallel processing subsystems 712 can be distributed across any number of shared geographic locations and/or any number of different geographic locations and/or implemented in one or more cloud computing environments (i.e., encapsulated shared resources, software, data, etc.) in any combination.

The system memory 704 can include, without limitation, any number and/or types of system software (e.g., operating systems, device drivers, library programs, utility programs, etc.), any number and/or types of software applications, or any combination thereof. The system software and the software applications included in the system memory 704 can be organized in any technically feasible fashion.

As shown, in some embodiments, the system memory 704 includes, without limitation, a programming platform software stack 760 and a software application 790. The programming platform software stack 760 is associated with a programming platform for leveraging hardware in the parallel processing subsystem 712 to accelerate computational tasks. In some embodiments, the programming platform is accessible to software developers through, without limitation, libraries, compiler directives, and/or extensions to programming languages. In the same or other embodiments, the programming platform can be, but is not limited to, Compute Unified Device Architecture (CUDA) (CUDA® is developed by NVIDIA Corporation of Santa Clara, Calif.), Radeon Open Compute Platform (ROCm), OpenCL (OpenCL™ is developed by Khronos group), SYCL, or Intel One Application Programming Interface.

In some embodiments, the programming platform software stack 760 provides an execution environment for the software application 790 and zero or more other software applications (not shown). In the same or other embodiments, the software application 790 can include, without limitation, any computer software capable of being launched on the programming platform software stack 760. In some embodiments, the software application 790 can be, but is not limited to, an artificial intelligence application or workload, a machine learning application or workload, a deep learning application or workload, a high-performance computing application or workload, a virtual desktop infrastructure, or a data center workload.

In some embodiments, the software application 790 and the programming platform software stack 760 execute under the control of the CPU 702. In the same or other embodiments, the software application 790 can access one or more parallel processors included in the parallel processing subsystem 712 via the programming platform software stack 760. For explanatory purposes, the CPU 702 and any number of parallel processors included in the parallel processing subsystem 712 are referred to in the context of FIG. 7 as “the processors.” for explanatory purposes.

In operation, the software application 790 and/or any number of other software applications cause one or more of the processors to execute any number of instructions sequentially, concurrently, or in any combination thereof. Each instruction can specify, without limitation, an opcode that specifies the instruction to be performed, zero or more operands, and any amount (including none) of addition data (e.g., instruction options, operand formats, etc.).

In some embodiments, as part of executing any number of instructions, one or more processors compute the maximum value of multiple multi-bit integer values via one or more maximum circuits (e.g., the maximum circuit 100 of FIG. 1), one or more tiered maximum circuits (e.g., the tiered maximum circuit 300 of FIG. 3), one or more minimum/maximum circuits (e.g., the minimum/maximum circuit 500 of FIG. 5), or any combination thereof.

Note that the techniques described herein are illustrative rather than restrictive and may be altered without departing from the broader spirit and scope of the invention. Many modifications and variations on the functionality provided by the software application 790, the programming platform software stack 760, the CPU 702, the parallel processing subsystem 712, the parallel processors(s), the compute engine(s), and the resource manager will be apparent to those of ordinary skill in the art without departing from the scope and spirit of the described embodiments.

It will be appreciated that the system shown herein is illustrative and that variations and modifications are possible. The connection topology, including the number and arrangement of bridges, the number of the CPUs 702, and the number of the parallel processing subsystems 712, can be modified as desired. For example, in some embodiments, the system memory 704 can be connected to the CPU 702 directly rather than through the memory bridge 705, and other devices can communicate with the system memory 704 via the memory bridge 705 and the CPU 702. In some other alternative topologies, the parallel processing subsystem 712 can be connected to the I/O bridge 707 or directly to the CPU 702, rather than to the memory bridge 705. In still other embodiments, the I/O bridge 707 and the memory bridge 705 can be integrated into a single chip instead of existing as one or more discrete devices. Lastly, in certain embodiments, one or more components shown in FIG. 7 may not be present. For example, the switch 716 could be eliminated, and the network adapter 718 and the add-in cards 720, 721 would connect directly to the I/O bridge 707. In another example, the parallel processing subsystem 712 can be omitted from the system 700.

In sum, the disclosed techniques can be used to efficiently compute the maximum of multiple values, such as exponents of products in a floating point dot product unit. In some embodiments, a maximum circuit computes the maximum value of n r-bit input values via (2^{r}−1) different detection subcircuits and a parallel priority encoder. For a possible value i from (2^{r}−1) through 1, the i^{th} detection subcircuit outputs an i^{th} detection result of ‘1’ if any of the n input values is equal to i and outputs an i^{th} detection result of ‘0’ otherwise. The i^{th} detection result is the i^{th} bit of a (2^{r}−1)-bit data input to the parallel priority encoder, and the 0th bit of the data input is tied high. The parallel priority encoder encodes the bit position of the most significant ‘1’ bit of the data input to determine the maximum value of the n input values.

In the same or other embodiments, a tiered maximum circuit computes the maximum of n r-bit input values via m maximum circuits and (m−1) mask subcircuits, where m is an integer greater than 1. The tiered maximum circuit divides the r bit positions into m bit position sequences, where each bit position sequence is associated with a different maximum circuit. In some embodiments, the (m−1)th maximum circuit computes the (m−1)th portion of the maximum value 190 that includes the MSB based on the corresponding portions of the input values. For an integer j from (m−2) through 0, a j^{th} mask subcircuit routes the j^{th} portion of each input value in a j^{th} matching subset of the input values to a corresponding input of the j^{th} maximum circuit and a value of zero to each of the other inputs ports of the j^{th} maximum circuit. The j^{th} matching subset of the input values includes the one or more input values having MSBs that match the MSBs of the maximum value already computed by the one or more preceding maximum circuits. Accordingly, the j^{th} maximum circuit computes the j^{th} portion of the maximum value based on j^{th} portions of the one or more input values in the j^{th} matching subset of the input values. After the 0^{th} maximum circuit computes the LSB of the maximum value, the tiered maximum circuit outputs the maximum value.

At least one technical advantage of the disclosed techniques relative to the prior art is that, with the disclosed techniques, the delay incurred to double the number of exponents that are taken into account when computing maximum exponents is reduced. In that regard, with the disclosed techniques, because comparisons are performed between each exponent and possible values instead of between exponents, the increase in delay attributable to doubling the number of exponents is on the order of the delay of a two-input or gate instead of the sum of the delays of a comparator and a multiplexer. Furthermore, because adding a pipeline stage to a tiered maximum circuit in a pipelined floating point matrix multiplication datapath involves storing only a portion of a single exponent, the tiered maximum circuit is well-suited for pipelining. These technical advantages provide one or more technological improvements over prior art approaches.

Any and all combinations of any of the claim elements recited in any of the claims and/or any elements described in this application, in any fashion, fall within the contemplated scope of the embodiments and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program codec embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory, a read-only memory, an erasable programmable read-only memory, Flash memory, an optical fiber, a portable compact disc read-only memory, an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A circuit comprising:
a first plurality of detection subcircuits, wherein each detection subcircuit included in the first plurality of detection subcircuits computes a different detection result that is included in a first plurality of detection results and indicates whether at least one input value included in a plurality of input values is equal to a different integer; and
a first encoder coupled to the first plurality of detection subcircuits that:
determines a first active bit or a last active bit from first encoder input data, wherein each detection result included in the first plurality of detection results comprises a different bit of the first encoder input data; and
encodes a bit position associated with the first active bit or the last active bit to generate a maximum value or a minimum value.

2. The circuit of claim 1, wherein the first encoder generates the maximum value, and further comprising:
a first plurality of inverters coupled to the first plurality of detection subcircuits that invert a plurality of sources to generate the plurality of input values; and
a second plurality of inverters coupled to the first encoder that invert the maximum value to generate the minimum value.

3. The circuit of claim 1, wherein the first encoder comprises a parallel priority encoder or a trailing one detector

4. The circuit of claim 1, wherein a first detection subcircuit included in the first plurality of detection subcircuits comprises:
a plurality of match detectors; and
an OR component coupled to the plurality of match detectors.

5. The circuit of claim 1, further comprising:
a plurality of pipelining flip-flops coupled to the first encoder that store the maximum value or the minimum value.

6. The circuit of claim 1, wherein the plurality of input values correspond to a highest bit position sequence in a plurality of overall input values, the maximum value or the minimum value is represented via the highest bit position sequence of an overall maximum value or an overall minimum value, and further comprising:
a mask subcircuit coupled to the first encoder that generates a plurality of next values associated with a next bit position sequence based on the plurality of overall input values and the maximum value or the minimum value;
a second plurality of detection subcircuits coupled to the mask subcircuit that computes a second plurality of detection results; and
a second encoder coupled to the second plurality of detection subcircuits that determines a next maximum value or a next minimum value that is represented via the next bit position sequence of the overall maximum value or the overall minimum value

7. The circuit of claim 6, further comprising:
a plurality of pipelining flip-flops coupled to the mask subcircuit that store the plurality of next values.

8. The circuit of claim 6, wherein the overall maximum value or the overall minimum value comprises a maximum or a minimum of the plurality of overall input values.

9. The circuit of claim 1, wherein a least significant bit or a most significant bit of the first encoder input data comprises a binary value of one.

10. The circuit of claim 1, wherein a number of detection subcircuits included in the first plurality of detection subcircuits is one less than two to the power of a number of bits in each input value included in the plurality of input values.

11. The circuit of claim 1, wherein the circuit of claim 1 comprises a maximum circuit that is included in a floating point matrix multiplication datapath or a pipelined floating point matrix multiplication datapath.

12. A method for performing maximum computations or minimum computations, the method comprising:
performing one or more detection operations on a plurality of input values to compute a first plurality of detection results, wherein each detection result included in the first plurality of detection results indicates whether at least one input value included in the plurality of input values is equal to a different integer;
detecting a first active bit or a last active bit from first encoder input data, wherein each detection result included in the first plurality of detection results comprises a different bit of the first encoder input data; and
encoding a first bit position or a last bit position associated with the first active bit or the last active bit to generate a maximum value or a minimum value.

13. The method of claim 12, wherein the first bit position is encoded to generate the maximum value and further comprising:
inverting a plurality of sources to generate the plurality of input values; and
inverting the maximum value to generate the minimum value.

14. The method of claim 12, further comprising storing the maximum value or the minimum value to enable one or more pipelining operations.

15. The method of claim 12, wherein the plurality of input values correspond to a highest bit position sequence in a plurality of overall input values, the maximum value or the minimum value is represented via the highest bit position sequence of an overall maximum value or an overall minimum value, and further comprising:
generating a plurality of next values associated with a next bit position sequence based on the plurality of overall input values and the maximum value or the minimum value;
performing one or more detection operations on the plurality of next values to generate a second plurality of detection results;
detecting a second active bit from second encoder input data, wherein each detection result included in the second plurality of detection results comprises a different bit of the second encoder input data; and
encoding a second bit position associated with the second active bit to generate a next maximum value or a next minimum value that is represented via the next bit position sequence of the overall maximum value or the overall minimum value.

16. The method of claim 12, wherein the maximum value or the minimum value comprises a maximum or a minimum of the plurality of input values.

17. The method of claim 12, wherein a least significant bit of the first encoder input data comprises a binary value of one.

18. The method of claim 12, wherein the first plurality of detection results is associated with a range of integers that spans from one through one less than two to the power of a number of bits in each input value included in the plurality of input values.

19. The method of claim 12, wherein the plurality of input values comprises a plurality of exponents.

20. One or more non-transitory computer readable media including instructions that, when executed by one or more processors, cause the one or more processors to perform maximum computations by performing the steps of:
performing one or more detection operations on a plurality of input values to compute a first plurality of detection results, wherein each detection result included in the first plurality of detection results indicates whether at least one input value included in the plurality of input values is equal to a different integer;
detecting a first active bit or a last active bit from first encoder input data, wherein each detection result included in the first plurality of detection results comprises a different bit of the first encoder input data; and
encoding a first bit position or a last bit position associated with the first active bit or the last active bit to generate a maximum value or a minimum value.
